(19) United States
(12) Patent Application Publication
(10) Pub. No.: US 2018/0350041 A1
(43) Pub. Date: Dec. 6, 2018

(54) AEROTHERMAL RADIATION EFFECT FREQUENCY DOMAIN CORRECTION METHOD

(71) Applicant: HUAZHONG UNIVERSITY OF SCIENCE AND TECHNOLOGY, Wuhan (CN)

(72) Inventors: Tianxu ZHANG, Wuhan (CN); Xuan HOU, Wuhan (CN); Chuan ZHANG, Wuhan (CN); Li LIU, Wuhan (CN); Quan CHEN, Wuhan (CN); Ao ZHONG, Wuhan (CN); Mingxing XU, Wuhan (CN); Yutian ZHOU, Wuhan (CN)

(21) Appl. No.: 15/577,335

(22) PCT Filed: Apr. 13, 2016
(86) PCT No.: PCT/CN2016/079135

§ 371 Date: Nov. 27, 2017

(30) Foreign Application Priority Data
Dec. 23, 2015 (CN) 201510995105.X

(51) Int. Cl. G06T 5/00; G06T 5/40; G06T 5/10

(52) U.S. Cl. CPC G06T 5/002; G06T 5/40; G06T 5/10; G06T 2207/20072; G06T 2207/10048; G06T 2207/10032; G06T 2207/10016

(57) ABSTRACT

An aerothermal radiation effect frequency domain correction method, comprising: use a Gaussian surface to approximate a thermal radiation noise, perform a Fourier transform on the thermal radiation noise to obtain an amplitude spectrum, then normalize and segment the amplitude spectrum to obtain a filter thresholding template, BW, then use the filter thresholding template, BW, to construct a filter function, H; perform a Fourier transform on an image degraded by aerodynamic thermal radiation, f, to obtain a centralized frequency spectrum, F, then take the dot product of F and H to obtain a real-time image frequency spectrum, G; and perform an inverse Fourier transform on G to obtain a modulus, and acquire an image corrected for thermal radiation, g. Using the method effectively removes background noise generated by aerothermal radiation to restore a clear image, greatly improving image quality and image signal-to-noise ratio. The method further features reduced computational complexity and a shorter operation time, and is therefore better suited for real-time processing.

### CROSS-REFERENCE TO RELATED APPLICATIONS

This application is a National Stage Appl. filed under 35 USC 371 of International Patent Application No. PCT/CN2016/079135 with an international filing date of Apr. 13, 2016, designating the United States, and further claims foreign priority benefits to Chinese Patent Application No. 201510995105.X filed Dec. 23, 2015. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

### Field of the Invention

The present disclosure relates to the technical field of interdisciplinary sciences combining image processing and aerospace technology, and more particularly to a method for correcting for aerothermal radiation based on frequency-domain.

### Description of the Related Art

Development of supersonic aircrafts has become an important direction in the aerospace technology worldwide, and is of very high level of strategic importance in the fields of politics, military, and economics. However, the development of supersonic aircrafts faces a series of problems related to aero-optical effects, such as deteriorated imaging quality of images acquired by an image sensor and a large reduction of signal-to-noise ratio.

Aerothermal radiation effect generally refers to the following phenomena: when a high-speed aircraft carrying an optical imaging and detection system flies in the atmosphere, a complex flow field is produced due to interaction between an optical window and incoming airflow. Due to the impact of air viscosity, the airflow in contact with the surface of the optical window will be retarded, resulting in a decrease of the airflow velocity and a formation of a boundary layer near the surface of the optical window. Within the boundary layer, the airflow layers having a relatively large velocity gradient will produce strong friction, which irreversibly converts kinetic energy of the airflow into thermal energy, causing rise of the temperature on the walls of the optical window. The high-temperature airflow will continuously transfer heat to the low-temperature walls, causing strong aerothermal heating and thus bringing radiation interference to an imager. This increases the background brightness of an infrared image, deteriorates quality of infrared imaging, and significantly affects navigation, positioning and detection performances of a supersonic aircraft.

Although some aerothermal-radiation-effect correction methods have been reported in related documents or patents, these methods are problematic because of their complex and time-consuming algorithms or because they provide only one modeling method, and thus these methods are inapplicable to real-time processing. Therefore, there is an urgent need in the art to provide a new real-time correction method.

### SUMMARY OF THE INVENTION

In view of the above-described problems, it is one objective of the invention to provide a method for correcting for aerothermal radiation based on frequency-domain. The method analyzes spectral distribution of thermal noise to establish a filter, and filters out spectral components of aerothermal radiation noise in frequency-domain to restore a clear image, thereby significantly improving quality and signal-to-noise ratio of images; therefore, the method is particularly suitable for applications in conditions of high-speed flight of supersonic aircrafts, where the aerothermal radiation effect and the like exist.

To achieve the above objective, in accordance with one embodiment of the invention, there is provided a method for correcting for aerothermal radiation based on frequency-domain, the method comprising:
1) acquiring an aerothermal-radiation degraded image f from a real-time video image library;
2) approximating the aerothermal-radiation degraded image f to obtain an aerothermal-radiation-noise Gaussian curved-surface b, and performing Fourier transform to the Gaussian curved-surface b, followed by spectrum-centralization, to obtain the aerothermal-radiation-noise spectrum B;
3) acquiring a filtering-mask constraint from the aerothermal-radiation-noise spectrum B obtained in 2), and establishing a filter function H;
4) performing Fourier transform to the aerothermal-radiation degraded image f, followed by spectrum-centralization, to obtain a centralized spectrum F of the aerothermal-radiation degraded image;
5) performing dot-product of the centralized spectrum F and the filter function H, to yield a filtered spectrum G of a real-time image; and
6) centralizing the filtered spectrum G of the real-time image, and performing inverse Fourier transform and modulo operations, to obtain an aerothermal-radiation corrected image.

In a class of this embodiment, step 2) comprises:

firstly, acquiring a size m×n of the aerothermal-radiation degraded image in 1); next, establishing an aerothermal-radiation-noise Gaussian curved-surface b in the same size as the degraded image, by using a Gaussian function

$$gaussian ( m , n ) = {e}^{\frac{- ( {m}^{2} + {n}^{2} )}{2 {σ}^{2}}} ,$$

where, m and n represent the rows and columns of the two-dimensional Gaussian function, respectively, and σ represents the standard deviation; then, performing Fourier transform to the aerothermal-radiation-noise Gaussian curved-surface, followed by spectrum centralization, to obtain the aerothermal-radiation-noise spectrum B.

In a class of this embodiment, step 3) comprises:

(3-1) estimating an amplitude spectrum B̅ of the aerothermal-radiation-noise spectrum B in 2), where B̅=|B|;

(3-2) normalizing the amplitude spectrum B̅, to obtain a normalized amplitude spectrum N, and drawing a statistical histogram Hist(x) thereof, where the abscissa represents a normalized amplitude value;

(3-3) according to the histogram Hist(x), estimating a segmentation threshold γ, and then using the segmentation threshold γ to segment the normalized amplitude spectrum N, where, a value of γ is in the range of 0-1;

(3-4) based on the segmentation threshold γ, performing threshold-based segmentation of the normalized amplitude spectrum N, thus obtaining filtering-mask constraint BW; and

(3-5) based on the obtained filtering-mask constraint BW, establishing a corresponding filter function H, which specifically is as follows:

$$H ( u , v ) = \{ \begin{matrix}1 & BW ( u , v ) = 1 \\ λ & BW ( u , v ) = 0\end{matrix}$$

where, BW (u, v) represents an arbitrary point on BW; H (u, v) represents an arbitrary point on the filter function H, and (u, v) represents coordinates of the point; λ represents the degree of aerothermal-radiation-noise-filtering, with its value in the range of 0-1.

In a class of this embodiment, segmenting the normalized amplitude spectrum comprises: for every point N̅(̅u̅,̅ v̅)̅ in the normalized amplitude spectrum N, if N̅(̅u̅,̅ v̅)̅≥γ, then setting the corresponding point in the filtering-mask constraint BW to be BW (u, v)=0; otherwise, setting BW (u, v)=1.

In a class of this embodiment, the filtering-mask constraint is a binary-mask constraint.

In general, compared with the prior art, the method for correcting for aerothermal radiation of the present disclosure mainly have the following technical advantages:

1. In the present application, in conjunction with the practical need for frequency-domain correction of aerothermal radiation effect, and in view of the problem of deteriorated real-time performance of algorithms due to complex matrix operations and repeated iterations and the like in the existing frequency-domain correction methods for aerothermal radiation effect, a novel method for correcting for aerothermal radiation based on frequency-domain is proposed, which only requires one time of Fourier transform and inverse Fourier transform to images to accomplish the entire correction procedure, and greatly enhances signal-to-noise ratio of images while effectively suppressing aerothermal radiation noise, and has the feature of high-level real-time performance.

2. Moreover, in the method of the present disclosure, a filter is established by analyzing spectrum distribution of aerothermal radiation noise, then the filter is used to filter out the spectral components of the aerothermal radiation noise in frequency-domain to restore a clear image; in this way, the method not only ensures significant improvement in quality and signal-to-noise ratio of images, but also reduces computational complexity of the correction method as much as possible, thereby significantly reduces the time consumption for correction.

### BRIEF DESCRIPTION OF THE DRAWINGS

FIG. 1 is a flowchart of the method for correcting for aerothermal radiation based on frequency-domain, according to the present disclosure;

FIG. 2 shows an aerothermal-radiation-noise Gaussian curved-surface obtained by approximation processing;

FIG. 3 is a schematic diagram illustrating the spectrum-centralization processing;

FIG. 4 shows the corresponding amplitude spectrum of the aerothermal-radiation-noise Gaussian curved-surface of FIG. 2;

FIG. 5 shows filtering-mask constraint BW of the filter function H;

FIG. 6 shows a three-dimensional view of the filter function H;

FIG. 7 is a reference image;

FIG. 8 shows the centralized spectrum of the reference image;

FIG. 9 shows an acquired aerothermal-radiation degraded image f;

FIG. 10 shows the centralized spectrum F of FIG. 9;

FIG. 11 shows the filtered spectrum G of the real-time image;

FIG. 12 shows the aerothermal-radiation corrected image g after frequency-domain correction of aerothermal radiation effect;

FIG. 13A shows a simulated aerothermal-radiation degraded image according to actual flight conditions, in an embodiment;

FIG. 13B shows an aerothermal-radiation corrected image obtained by using the correction method of the present disclosure, in the embodiment;

FIG. 13C is a reference image;

FIG. 13D shows the result of comparing the values of the same row pixels taken from FIG. 13A, FIG. 13B and FIG. 13C, respectively;

FIG. 14A is a 2000^{th}-frame aerothermal radiation image acquired by an infrared imaging system in a wind tunnel experiment, according to an embodiment;

FIG. 14B is an aerothermal-radiation corrected image obtained in the embodiment by using the correction method of the present disclosure;

FIG. 14C is the 1^{st}-frame image in the wind tunnel experiment in the embodiment;

FIG. 14D shows the result of comparing the values of the same row pixels taken from FIG. 14A, FIG. 14B and FIG. 14C, respectively;

FIG. 15A is a simulated aerothermal-radiation degraded image of a simple background spot-source target, according to an embodiment;

FIG. 15B is an aerothermal-radiation corrected image obtained in the embodiment by using the correction method of the present disclosure;

FIG. 15C is a reference image of the spot-source target; and

FIG. 15D shows the result of comparing the values of the same row pixels taken from FIG. 15A, FIG. 15B and FIG. 15C, respectively.

### DETAILED DESCRIPTION OF THE PREFERRED EMBODIMENTS

To better explain the present disclosure, the main contents of the present disclosure are further set forth below by use of specific examples, but the contents of the present disclosure are not limited to the examples below.

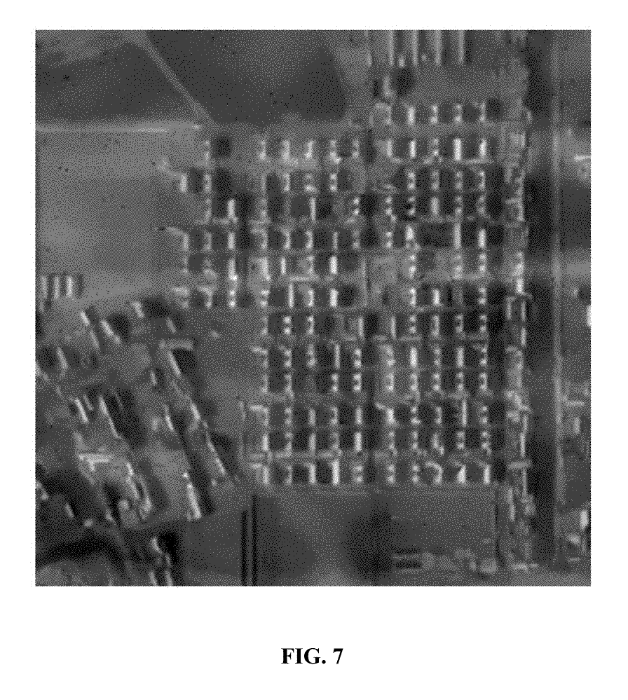

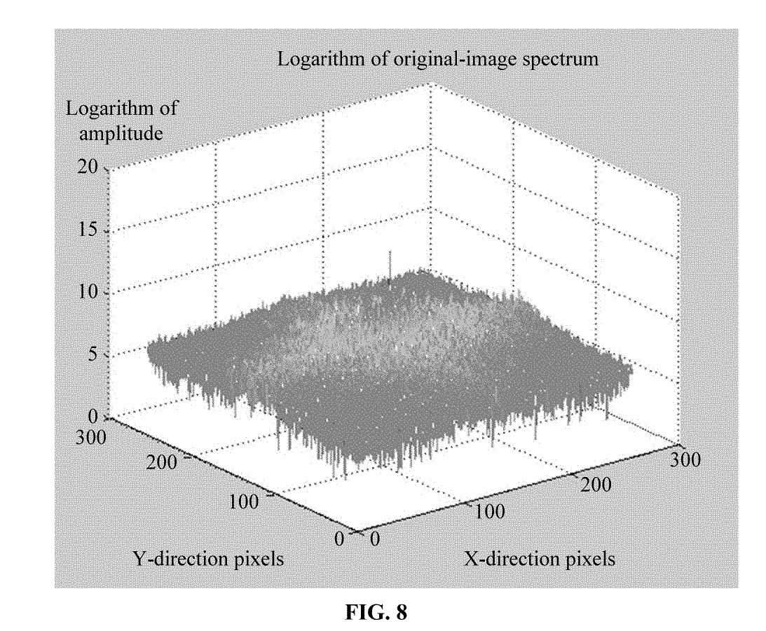

The method of the present disclosure, through comparison and analysis of a series of aerothermal-radiation degraded images and original reference images, as shown in FIGS. 7-10, finds out that aerothermal-radiation noise in an aerothermal-radiation degraded image is in a low-frequency distribution, with a shape similar to a Gaussian curved-surface, and its spectral distribution is regular and ordered, in a “cross” shape which has a tendency to gradually attenuate towards the surrounding area.

Thus, it is known from the above analysis that, aerothermal-radiation noise can be approximated by a Gaussian curved-surface, which will be described below in detail.

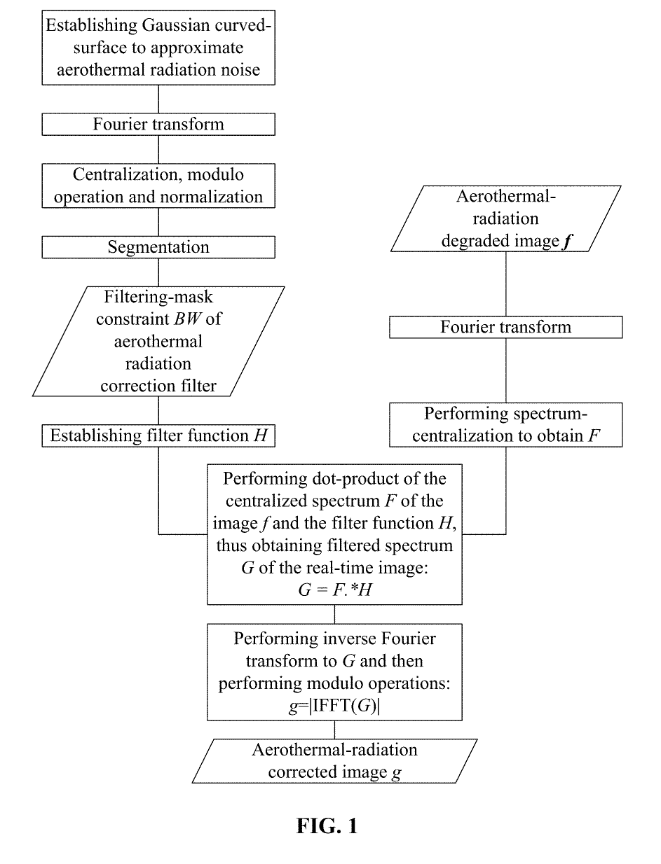

As shown in FIG. 1, it shows a flowchart of the method for correcting for aerothermal radiation based on frequency-domain, according to the present disclosure, and the method comprises the following steps:

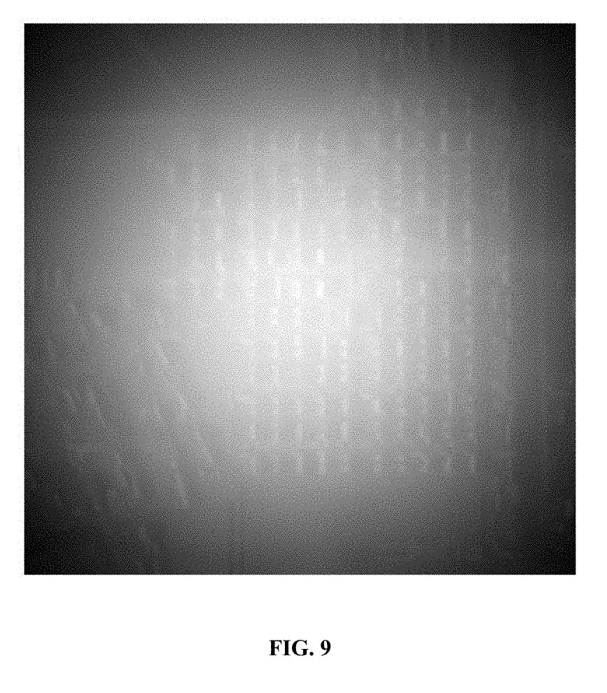

(1) acquiring an aerothermal-radiation degraded image f from video images, as shown in FIG. 9;

(2) approximating the aerothermal-radiation degraded image f to obtain an aerothermal-radiation-noise Gaussian curved-surface b, and performing Fourier transform to the Gaussian curved surface b, followed by spectrum-centralization, to obtain the aerothermal-radiation-noise spectrum B;

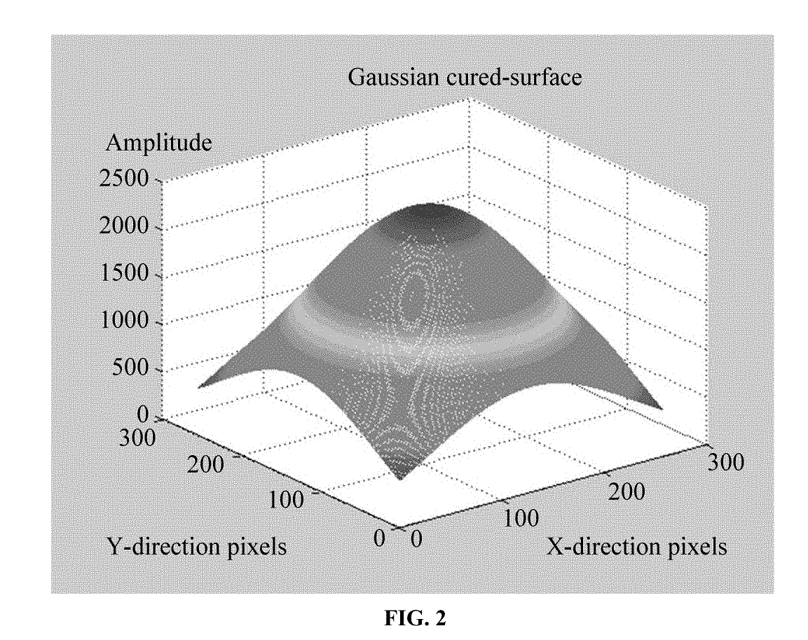

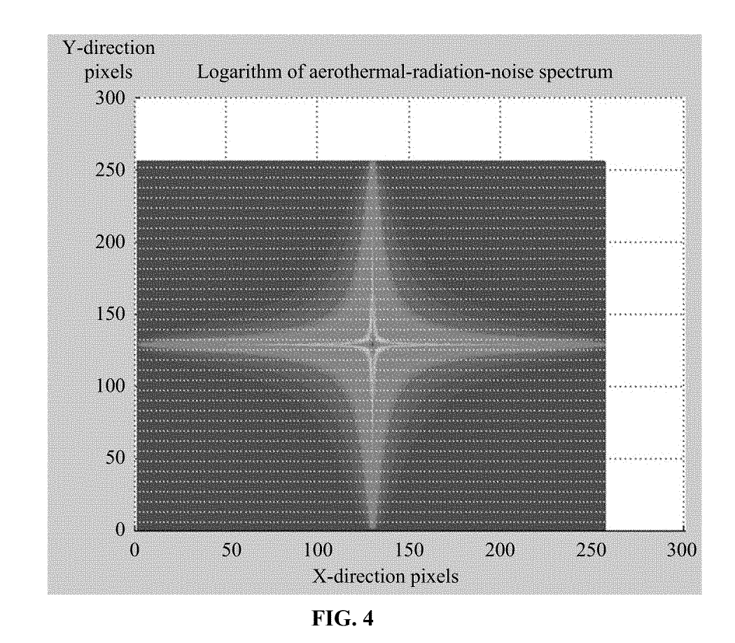

Step (2) comprises: firstly, acquiring the size m×n of the aerothermal-radiation degraded image used in step (1); next, establishing an aerothermal-radiation-noise Gaussian curved-surface b in the same size as the degraded image, as shown in FIG. 2, by using a Gaussian function

$$gaussian ( m , n ) = {e}^{\frac{- ( {m}^{2} + {n}^{2} )}{2 {σ}^{2}}} ,$$

where, m and n represent the rows and columns of the two-dimensional Gaussian function, respectively, and σ represents the standard deviation; then, performing Fourier transform to the curved-surface, followed by spectrum centralization, to obtain the aerothermal-radiation-noise spectrum B, and further calculating its amplitude spectrum B̅, B̅=|B|,with the result shown in FIG. 4.

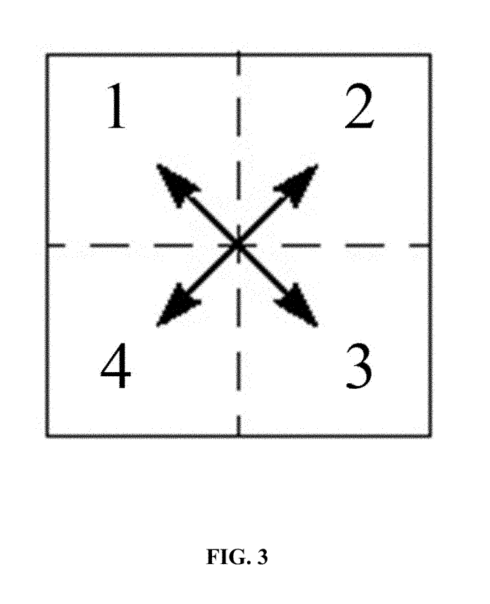

Specifically, as shown in FIG. 3, the amplitude spectrum B̅ of the aerothermal-radiation-noise Gaussian curved-surface b is equally divided into 2×2 sub-blocks, and then, spectrum centralization can be realized by exchanging the first sub-block with the third sub-block and exchanging the second sub-block with the fourth sub-block in the figure. The centralized spectrum of the image has low frequencies distributed at the center and high frequencies distributed in the surrounding area.

(3) acquiring a filtering-mask constraint from the aerothermal-radiation-noise spectrum B obtained in step (2), and establishing a filter function H;

Step (3) comprises:

(3-1) from the aerothermal-radiation-noise spectrum B obtained in step (2), estimating its amplitude spectrum B̅, B̅=|B|;

(3-2) normalizing the amplitude spectrum B̅, to obtain a normalized amplitude spectrum N, and drawing a statistical histogram Hist(x), where the abscissa x represents a normalized amplitude value;

(3-3) according to the histogram Hist(x), estimating a segmentation threshold γ, and then using the segmentation threshold γ to segment the normalized amplitude spectrum N, thus obtaining filtering-mask constraint BW, where, the filtering-mask constraint is binary-mask constraint; the segmentation threshold γ indicates the amount of the filtered-out spectral components, with its value in the range of 0-1; the greater γ, the more filtered-out spectral components, and in this embodiment, γ=0.55.

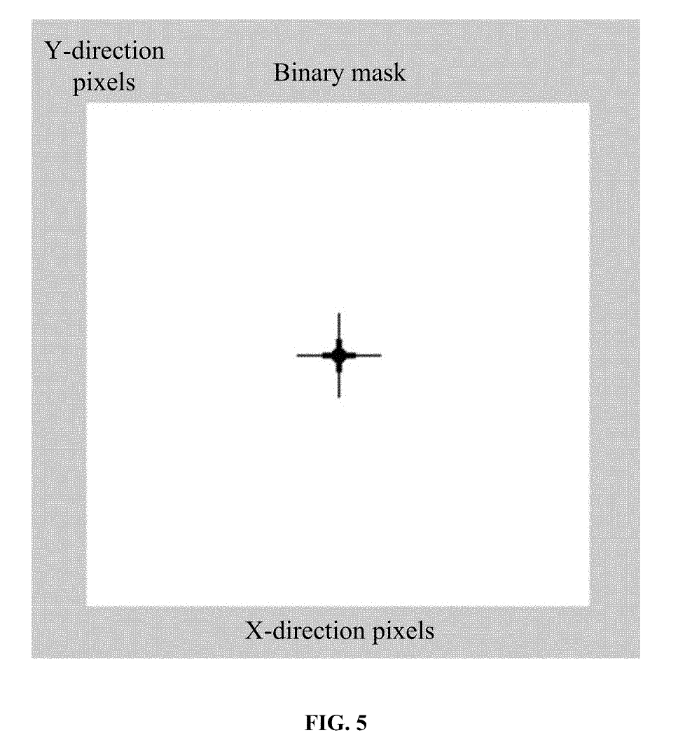

Specifically, the threshold-based segmentation comprises the following process: for every point N̅(̅u̅,̅ v̅)̅ in the normalized amplitude spectrum N, if N̅(̅u̅,̅ v̅)̅≥γ, then setting the corresponding point in the filtering-mask constraint BW to be BW (u, v)=0, otherwise, setting BW (u, v)=1. The result B of the threshold-based segmentation is as shown in FIG. 5;

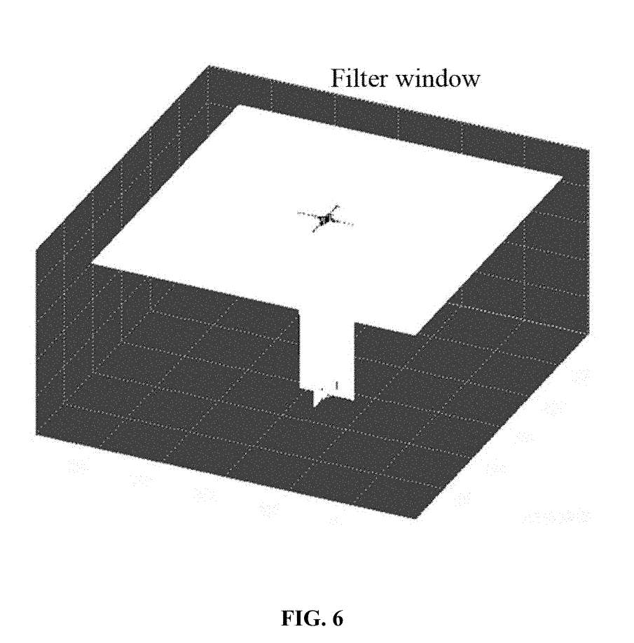

(3-4) based on the obtained filtering-mask constraint BW, establishing a corresponding filter function H, of which a three-dimensional view is as shown in FIG. 6, the filter function being specifically as follows:

$$H ( u , v ) = \{ \begin{matrix}1 & BW ( u , v ) = 1 \\ λ & BW ( u , v ) = 0\end{matrix}$$

where, BW (u, v) represents an arbitrary point on BW; H (u, v) represents an arbitrary point on the filter function H, and (u, v) represents coordinates of the point; λ represents the degree of aerothermal-radiation-noise-filtering, with its value in the range of 0-1. The smaller λ, the higher degree of aerothermal-radiation-noise-filtering, and the appropriate value of λ may be selected according to the intensity of the aerothermal radiation noise, and in this embodiment, λ=0.05;

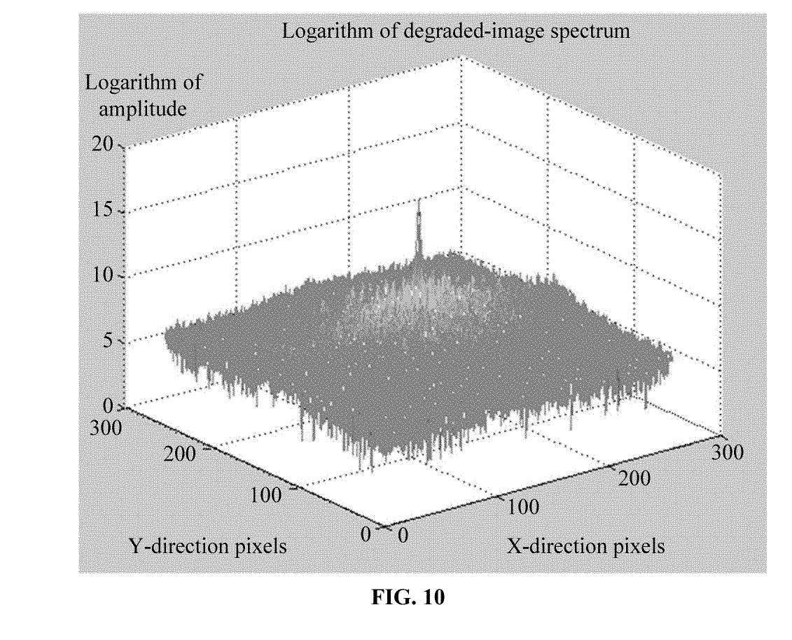

(4) performing Fourier transform to the aerothermal-radiation degraded image f, followed by spectrum-centralization, to obtain a centralized spectrum F of the aerothermal-radiation degraded image, as shown in FIG. 10;

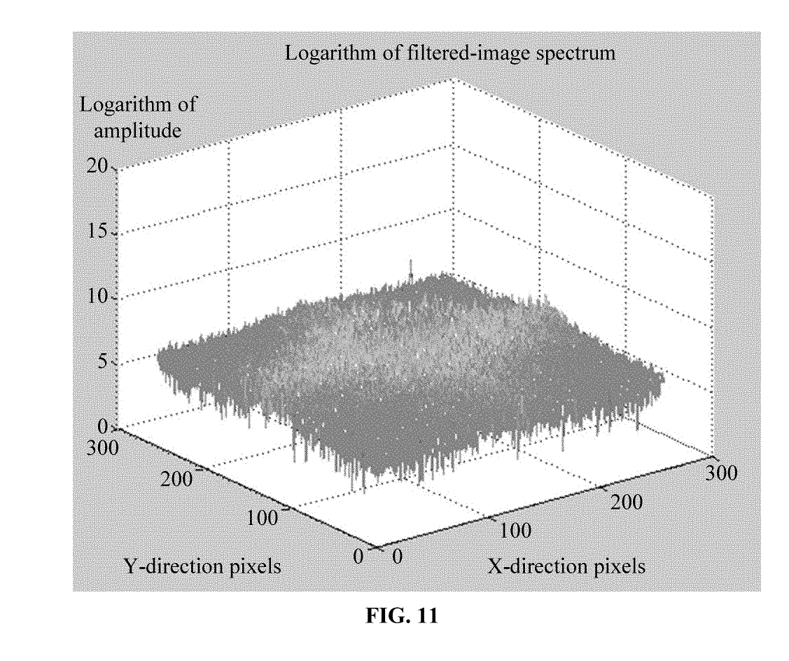

(5) performing dot-product of the centralized spectrum F and the filter function H, to yield a filtered spectrum G of the real-time image, i.e., G=F.*H, as shown in FIG. 11, so that frequency-domain filtering to f is achieved;

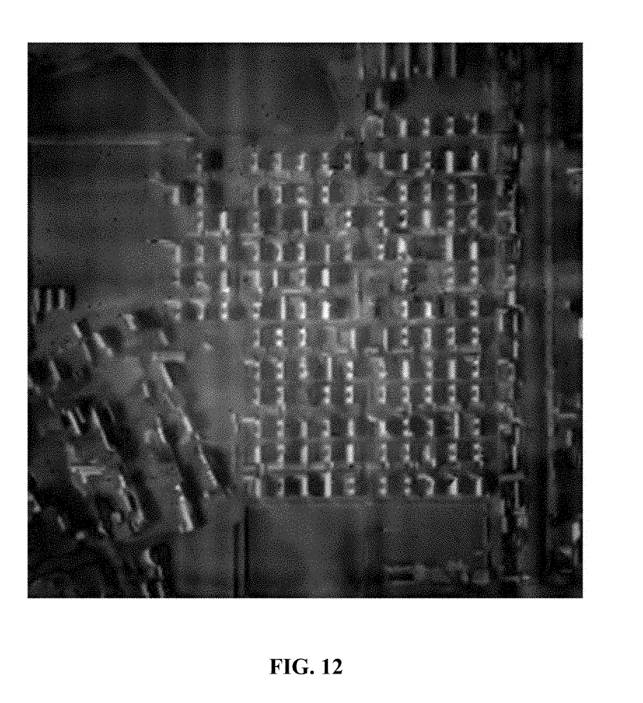

(6) centralizing the filtered spectrum G of the real-time image, and performing inverse Fourier transform and modulo operations, to obtain an aerothermal-radiation corrected image g, as shown in FIG. 12.

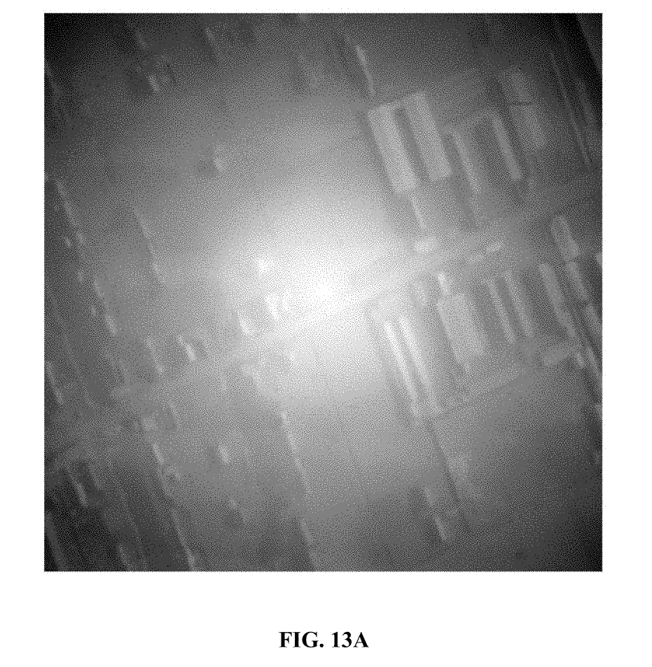

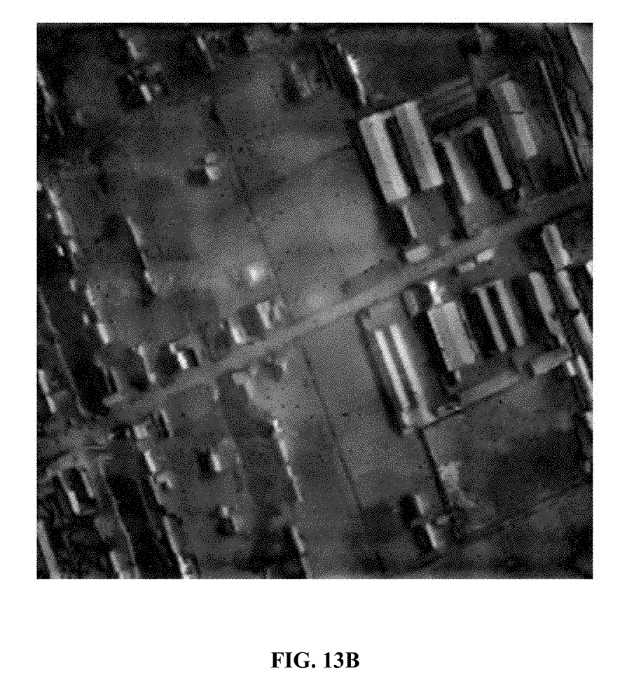

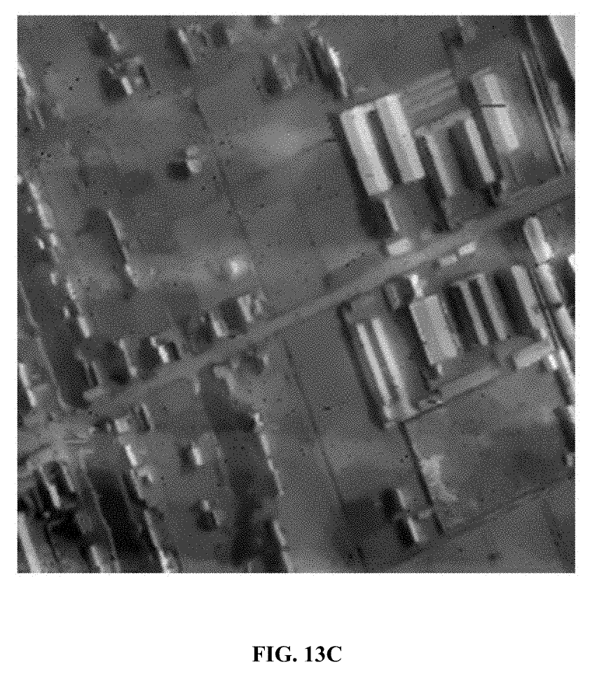

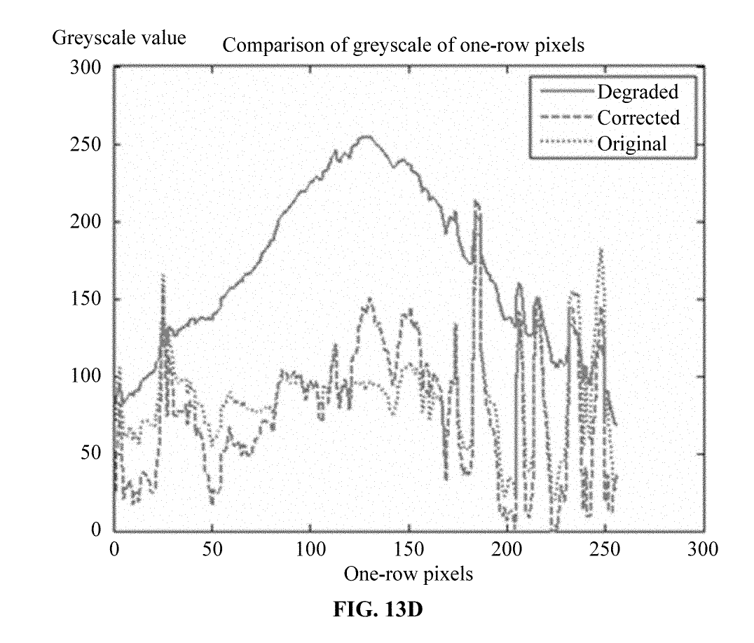

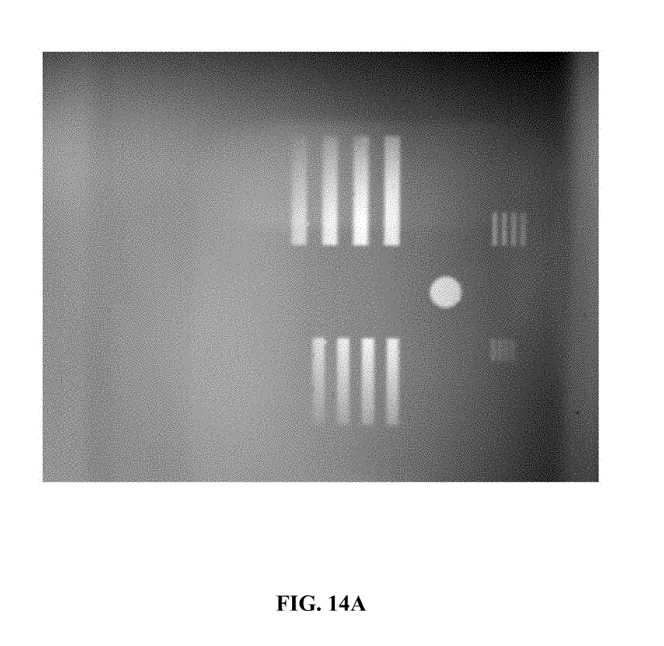

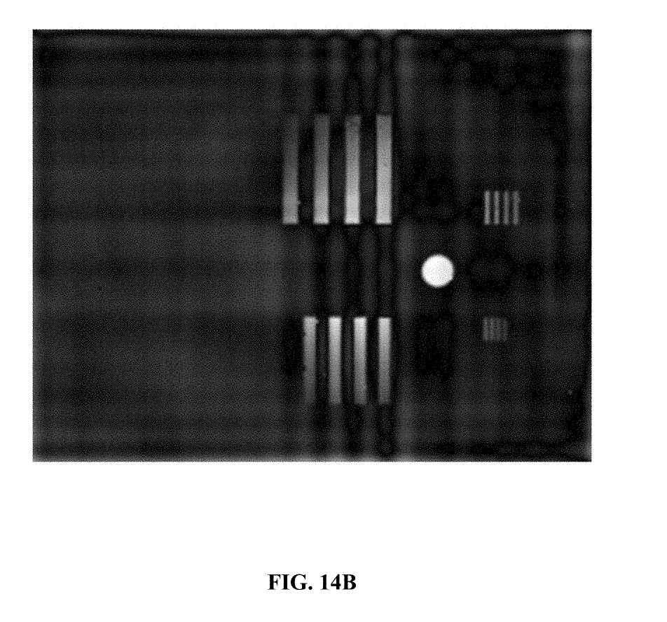

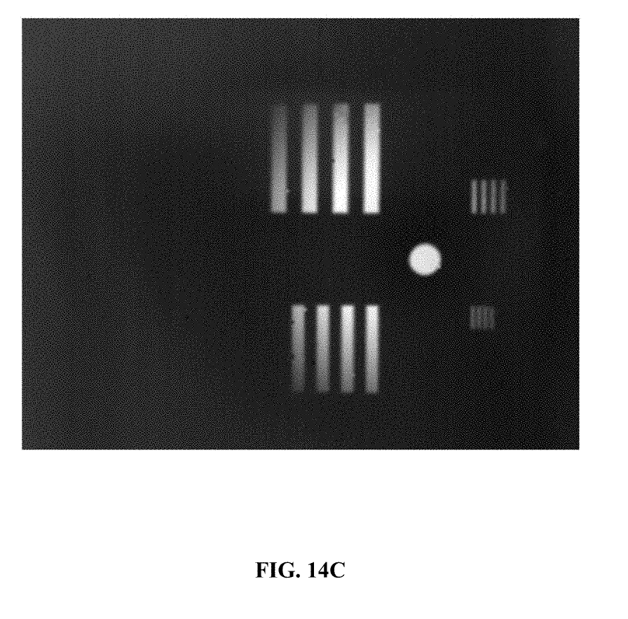

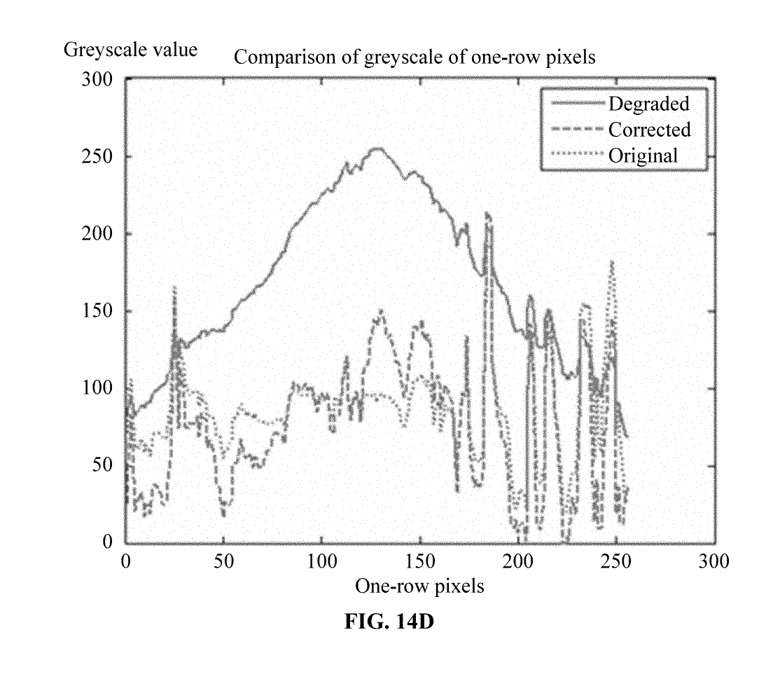

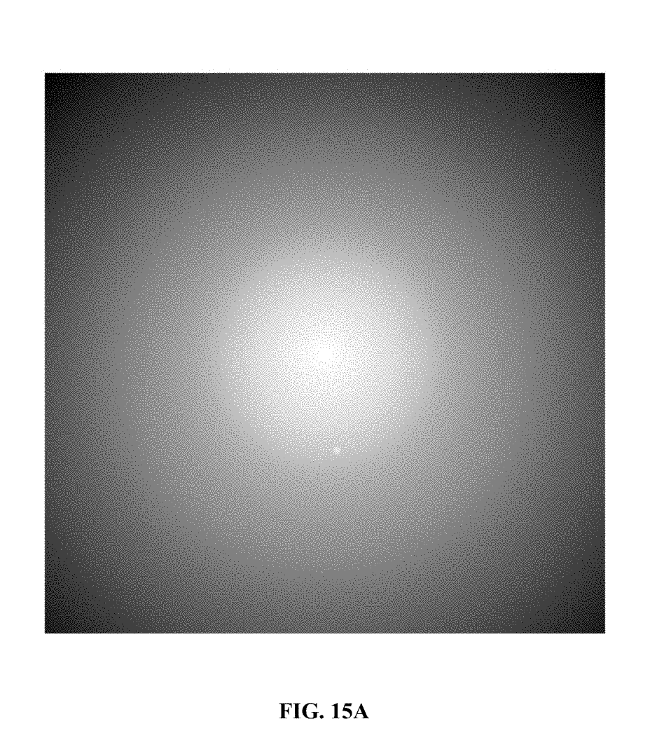

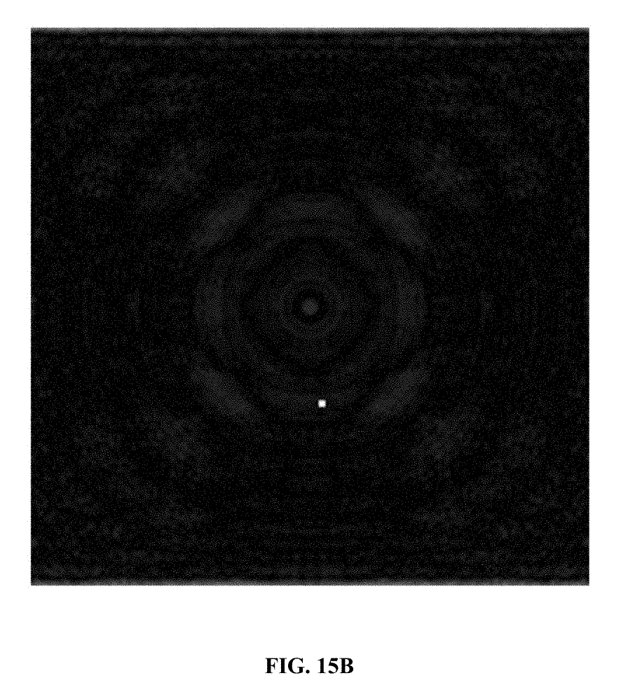

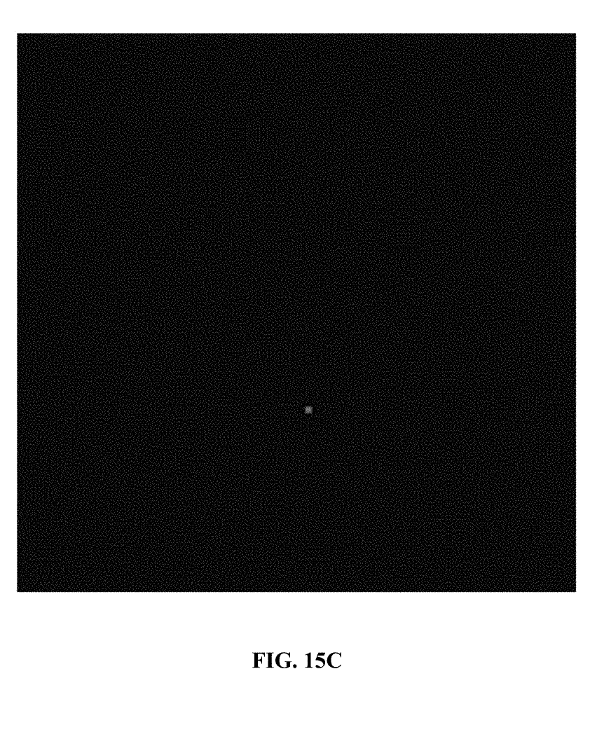

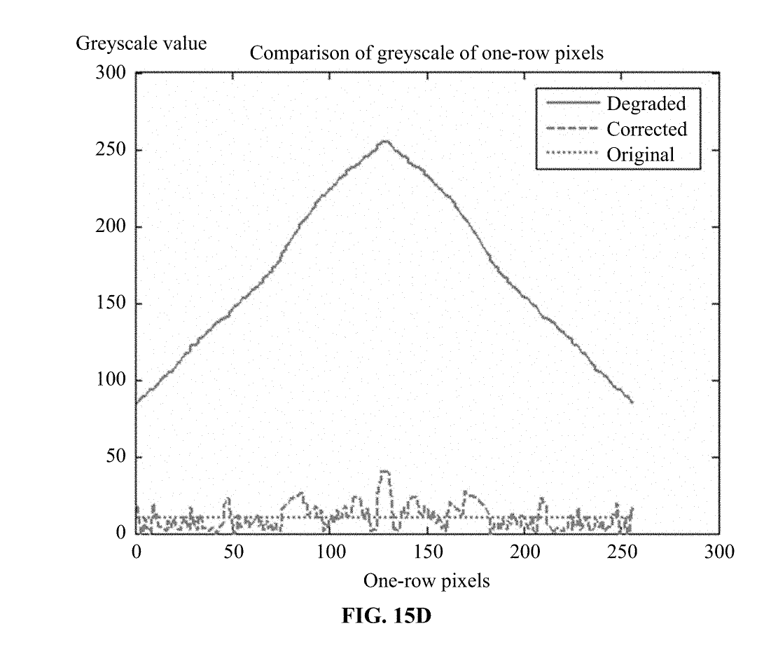

Based on steps described above, three groups of different aerothermal-radiation degraded images are processed, respectively, to verify the present disclosure, and the result is as shown in FIGS. 13-15.

TABLE 1

| | PSNR (after | PSNR (after | |
|---|---|---|---|
| | aerothermal | frequency- | |
| | radiation | domain | Time |
| | degradation) | correction) | consumption |
| Image 1 | 11.7837 | 15.9239 | 0.0761 s |
| Image 2 | 9.0293 | 21.6188 | 0.0676 s |
| Image 3 | 6.3180 | 26.9207 | 0.0776 s |

As can be derived from comparison of the data in Table 1, the correction algorithm of the present disclosure can significantly improve peak signal-to-noise ratio of aerothermal-radiation degraded images, thus can effectively solve the problem of aerothermal radiation effect. The time consumption is obtained by running the algorithm of the present disclosure on MATLAB.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

1. A method for correcting for aerothermal radiation, the method comprising:
1) acquiring an aerothermal-radiation degraded image f from a real-time video image library;
2) approximating the aerothermal-radiation degraded image f to obtain an aerothermal-radiation-noise Gaussian curved-surface b, performing Fourier transform to the Gaussian curved-surface b, followed by spectrum-centralization, to obtain an aerothermal-radiation-noise spectrum B;
3) acquiring a filtering-mask constraint from the aerothermal-radiation-noise spectrum B obtained in 2), and establishing a filter function H;
4) performing Fourier transform to the aerothermal-radiation degraded image f, followed by spectrum-centralization, to obtain a centralized spectrum F of the aerothermal-radiation degraded image;
5) performing dot-product of the centralized spectrum F and the filter function H, to yield a filtered spectrum G of a real-time image; and
6) centralizing the filtered spectrum G of the real-time image, and performing inverse Fourier transform and modulo operations, to obtain an aerothermal-radiation corrected image.

2. The method of claim 1, wherein 2) comprises: first, acquiring a size m×n of the aerothermal-radiation degraded image in 1); next, establishing the aerothermal-radiation-noise Gaussian curved-surface b in the same size as the degraded image, by using a Gaussian function
$$gaussian ( m , n ) = {e}^{\frac{- ( {m}^{2} + {n}^{2} )}{2 {σ}^{2}}} ,$$
where, m and n represent rows and columns of the two-dimensional Gaussian function, respectively, and σ represents a standard deviation; then, performing Fourier transform to the aerothermal-radiation-noise Gaussian curved-surface, followed by spectrum centralization, to obtain the aerothermal-radiation-noise spectrum B.

3. The method of claim 1, wherein step 3) comprises:
(3-1) estimating an amplitude spectrum B̅ of the aerothermal-radiation-noise spectrum B in 2), where B̅=|B|;
(3-2) normalizing the amplitude spectrum B̅, to obtain a normalized amplitude spectrum N, and drawing a histogram Hist(x) thereof, where an abscissa x of the histogram represents a normalized amplitude value;
(3-3) according to the histogram Hist(x), estimating a segmentation threshold γ, and segmenting the normalized amplitude spectrum N according to the segmentation threshold γ, to obtain a filtering-mask constraint BW, where, a value of the segmentation threshold γ is in the range of 0-1; and
(3-4) based on the obtained filtering-mask constraint BW, establishing a filter function H as follows:)
$$H ( u , v ) = \{ \begin{matrix}1 & BW ( u , v ) = 1 \\ λ & BW ( u , v ) = 0\end{matrix}$$
where, BW (u, v) represents an arbitrary point on the filtering-mask constraint BW; H (u, v) represents an arbitrary point on the filter function H, and (u, v) represents coordinates of the point; λ represents a degree of aerothermal-radiation-noise-filtering, and is in the range of 0-1.

4. The method of claim 3, wherein segmenting the normalized amplitude spectrum comprises: for every point N̅(̅u̅,̅ v̅)̅ in the normalized amplitude spectrum N, if N̅(̅u̅,̅ v̅)̅≥γ, then setting the corresponding point in the filtering-mask constraint BW to be BW (u, v)=0; otherwise, setting BW (u, v)=1.

5. The method of claim 1, wherein the filtering-mask constraint is a binary-mask constraint.

6. The method of claim 2, wherein the filtering-mask constraint is a binary-mask constraint.

7. The method of claim 3, wherein the filtering-mask constraint is a binary-mask constraint.

8. The method of claim 4, wherein the filtering-mask constraint is a binary-mask constraint.
